(19) United States
(12) Patent Application Publication
(10) Pub. No.: US 2016/0205965 A1
(43) Pub. Date: Jul. 21, 2016

(54) ONLINE PRINTING IN GUM MANUFACTURE AND PRODUCTS THEREOF

(71) Applicant: INTERCONTINENTAL GREAT BRANDS LLC, East Hanover, NJ (US)

(72) Inventors: Cesar Carlos Elejalde, Whippany, NJ (US); Amy L. Penner, Whippany, NJ (US); Richard John Baker, Whippany, NJ (US)

(21) Appl. No.: 14/915,373

(22) PCT Filed: Aug. 26, 2014
(86) PCT No.: PCT/US2014/052614

§ 371 Date: Feb. 29, 2016

Related U.S. Application Data
(60) Provisional application No. 61/849,843, filed on Aug. 30, 2013.

(51) Int. Cl. A23G 4/06; B41J 3/407; A23G 4/18

(52) U.S. Cl. CPC A23G 4/062; A23G 4/18; A23P 1/081; B41J 3/407; A23P 2001/089

(57) ABSTRACT

Disclosed is a method of manufacturing a gum product comprises forming a gum mass into a gum sheet and printing on at least one surface of the gum sheet, wherein the gum sheet is printed online within 30 minutes of forming the gum sheet.

### CROSS REFERENCE TO RELATED APPLICATIONS

This application is a National Stage application of PCT/US2014/052614, filed Aug. 26, 2014, which claims the benefit of U.S. Provisional Application No. 61/849,843, filed Aug. 30, 2013, both of which are incorporated by reference in their entirety herein.

### FIELD

The present invention relates generally to gum manufacturing methods and systems and more particularly to online printing of the gum during its manufacture.

### BACKGROUND OF THE INVENTION

It is generally known to print edible inks onto confectionery products. Confectionery products having visually pleasing appearances can lead to enhanced marketability with consumers. The process of making gum products, however, is a complex and time-consuming process, so that integrating a printing operation into gum manufacture can involve considerable difficulties and cost. Thus, online printing on a commercial scale remains a challenging concept.

Traditionally, an online process of manufacturing gum products can include, once the composition of the finished gum has been made, extruding and forming the finished gum into shaped units, for example loaves, followed by conditioning the loaves of the finished gum, extruding the loaves into a continuous thin sheet of the finished gum, rolling the continuous sheet through a series of rollers to obtain a continuous gum sheet having a uniform reduced thickness, scoring and cutting the continuous sheet into individual sheets, conditioning the individual sheets, dividing the sheets into gum pieces, and packaging the gum pieces. Such processes of making gum products are disclosed, for example, in U.S. Pat. No. 6,254,373. WO 2013/013046 A2, and WO 2013/013041 A2, assigned to the present assignee or predecessor of interest of the present assignee, the teachings and disclosures of which are hereby incorporated by reference in their entireties to the extent not inconsistent with the present disclosure. Gum manufacture can, of course, vary depending on the selected manufacturing techniques and the final product. For example, a process of gum manufacture can generate various shapes of gum, including thin sticks, shorter and fatter slabs of gum, or even pellets.

Given the complexity of gum manufacture, integrating online printing into the gum manufacture can involve numerous considerations. For example, the gum, after it is formed into sheets, can change over time from a warm pliable material to a cool hardened material, which change can affect the texture of the surface on which printing occurs. The printing can also be affected by the presence of an anti-sticking agent that has been applied to the surface of gum sheets when subjected to rollers for sizing the gum. The quality of printing can depend on the specific type of printing employed and the characteristics of the markings made on the gum. A printed mark on the gum can be adversely affected by subsequent processing of the gum.

Specifically, the gum has typically been dusted with a suitable powder as an anti-sticking agent, in order to prevent sticking of the gum to rollers used during gum manufacture. Such treatment of the gum with anti-sticking agents, however, can pose a challenge for printing on the surface of the gum. The printed ink can have trouble adhering or sticking to the surface. The printed markings are more liable to be smeared or smudged. Thus, in order to obtain a gum product having a desired surface effect, some manufacturers, instead of limiting the coloring agent to the surface of the gum, have incorporated a coloring agent throughout the volume of the gum such that a corresponding colored design appears on the surface of the gum, as evident by a cross-sectional view of the gum.

Printing on gum has also been proposed as a separate off-line process, for example, in custom printing of individual pieces of gum product. Printing offline does not involve operating continuously with other steps in the process of gum manufacture. While this avoids the complexity of adapting the printing of gum to a continuous or large scale commercial process, such an approach is costly for use in large scale manufacturing.

Various methods of printing on a gum material have been proposed in the prior art. One such method involves contact printing such as rotogravure printing. Due to the nature of gravure printing, deforming of the gum via contact with an offset roller used for printing must be considered, depending on the temperature of the gum and its softness. Another problem to be considered regarding the use of rotogravure printing is that an anti-sticking agent on the gum can transfer onto the offset roller and thereby affect the adherence of the ink.

It would be advantageous to be able to print on gum in an online process during gum manufacture. It would also be advantageous to print on gum without having to remove any, some, or a substantial amount of anti-sticking agent from the gum

The present invention is directed toward an effective and efficient method of online printing on gum during the manufacture of gum products in order to provide high quality surface markings that can enhance the appearance of the gum for the consumer.

### BRIEF SUMMARY OF THE INVENTION

In one embodiment of the invention, a method of manufacturing a gum product comprises forming a gum mass into a gum sheet including a preselected sheet thickness profile and printing on at least one surface of the gum sheet, wherein the gum sheet is printed online less than 30 minutes after forming the gum sheet.

Another embodiment of the invention is directed to a method of manufacturing a gum product, the method comprising forming a gum mass into a gum sheet including a preselected gum thickness profile, applying an anti-sticking agent to at least one surface of the gum sheet, and printing on at least one surface of the gum sheet substantially without removing any of the anti-sticking agent, wherein the printing is online.

Another embodiment of the invention is directed to a method of manufacturing a gum product, the method comprising forming a gum mass into a gum sheet including a preselected gum thickness profile, applying an anti-sticking agent that is a liquid to at least one surface of the gum sheet, and printing on at least one surface of the gum sheet, wherein printing is online.

Another embodiment of the invention is directed to an edible gum product comprising a plurality of pieces of gum product, optionally packaged together, each piece predesigned for individual consumption, wherein 1 to 100% of the surface area of at least one surface is visually and/or transparently covered by dot-on-demand inkjet printer markings that comprise solidified hot-melt ink.

An advantage of the present method for making chewing gum is that the product can obtain an enhanced visual appearance. Another advantage of the present process is that online printing can be integrated in a continuous process of gum manufacture. Another advantage obtained by the present method is improved quality and adherence of surface markings printed on a chewing gum product.

### BRIEF DESCRIPTION OF THE DRAWINGS

The accompanying drawings incorporated in and forming a part of the specification embodies several aspects of the present invention and, together with the description, they serve to explain the principles of the invention. In the drawings:

FIG. 1 is a perspective illustration of a gum manufacturing system comprising online printing according to an embodiment;

FIG. 2 is a perspective illustration of one embodiment of a printing head that can be used in the system of FIG. 1;

FIGS. 3A and 3B are flow charts for alternate embodiments of a method of gum manufacture comprising online printing in accordance with the present method; and

FIGS. 4A and 4B are plan views of a gum product with exemplary surface markings printed in accordance with the present method.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The following disclosure will detail particular embodiments according to the present invention, which is directed to a method of producing a chewing gum product that can efficiently print, with high quality, markings that can provide improved consumer appeal. In particular, non-contact printing of hot-melt ink onto a gum sheet, during manufacture of the gum product, can be utilized to create a visual enhancement to the chewing gum product. Visually attractive markings on the surface of a chewing gum product can provide enhanced pleasure during product consumption. In addition, transparent markings can be printed alone or in combination with visual markings. The online printing of such markings can also provide a multi-sensory experience, delightful or interesting to the consumer.

In particular, as indicated above, the method of producing a gum product comprises forming a gum mass into a gum sheet that is subsequently subjected to online printing less than 30 minutes after forming the gum sheet. The formed gum sheet includes a desired preselected thickness profile, it being appreciated that the formed gum sheet can have a uniform or non-uniform sheet thickness in transverse cross-section and/or in machine-direction cross-section. The thickness profile can refer to a transverse cross-section of the gum sheet, specifically a profile having a length of about 50 percent to about 100 percent of the width of the sheet. More specifically, the thickness profile can be at least 80 percent, most specifically at least 90 percent, of a transverse cross-section of the gum sheet. The formed gum sheet can have a preselected thickness profile that is substantially the entire final transverse cross-sectional thickness of the gum sheet. The method can further include separating a formed gum sheet into a plurality of gum pieces and packaging the plurality of gum pieces, wherein each of the plurality of gum pieces includes a thickness profile that is substantially the same as a corresponding portion of the preselected thickness profile of the formed gum sheet.

Regarding the gum material, the structure thereof can be single layer, multiple layers, center-filled, coated, uncoated, co-deposited, or coextruded. The surface of the gum substrate can be substantially flat or can have surface regions that are convex, concave, curved, smooth, rough, wavy, contoured, or irregular with indentations and/or protrusions, as would be appreciated by the skilled artisan in the art of chewing gum products and their manufacture. Thus, the surface of the gum can have variable thickness, for example, cross-section transverse to the movement of a gum sheet being printed.

In one embodiment, the method is directed to online inkjet printing on a gum sheet within a relatively short time of forming the gum sheet. The printing applies an edible hot-melt ink. Thus, in one embodiment, printing occurs on a gum sheet while it is still in a warm, soft state, thereby avoiding additional later processing steps. Furthermore, the hot-melt printing can provide high resolution, non-smudge application of the ink, even when applied to a gum sheet having an anti-sticking agent. The online printing can be designed for incorporation into an integrated online process of manufacturing chewing gum. In one embodiment, the hot-melt ink is applied to a gum sheet coated with a liquid anti-sticking agent, for example an anti-sticking comprising an edible oil or other edible organic liquid. In another embodiment, the online printing involves applying hot-melt ink to a gum sheet having a particulate anti-sticking agent such as talc. The level of dust (anti-sticking material) can be controlled, within an allowed range, as further described below. Thus, optional de-dusting of a gum sheet prior to printing can be avoided by limiting the amount of particulate or non-particulate (liquid) anti-stick agent applied to the gum sheet in the first place, in which case later removal of the anti-sticking agent can be avoided or limited.

The online printing on a gum sheet can be advantageously carried out within a preselecting time, as early as within 30 minutes of forming the gum sheet, even when the gum sheet may still have a warm and soft texture. This can be accomplished prior to stacking of individual gum sheets and can be accomplished prior to optional conditioning or active cooling comprising force air, i.e., prior to hardening of the gum sheets in a cooling tunnel or the like. Thus, in one embodiment, the online printing is conducted prior to any tray stacking or conditioning of the gum and when the gum is still relatively warm, above room temperature.

The term “online printing” can be defined as a process wherein the printing on gum is at substantially the same rate (or mass velocity) that the gum leaves a forming station where the gum mass is first formed into a gum sheet. In particular, online printing can avoid or limit any off-line printing, which would necessitate additional handling or other special operations independent from the online processing of the gum sheet after being formed. Thus, printing can be conducted without adding undue complexity, time, and/or cost to current the gum manufacture. Online printing, however, can optionally include a surge line to further process a small or minor fraction of the product being produced online, as will be appreciated by the skilled artisan as being a normal option in online processing.

The ink formulation used for printing the gum sheets must be edible and subject to a phase change from liquid, when jetted, to solid, after being applied to the gum sheet. For example, a wax-based ink can be used, the composition of which can be selected for synergistic cooperation with the properties of the gum material and/or the anti-sticking agent on the surface of the gum sheet being printed. For example, the hot-melt ink not only has the property of solidifying within a short time of contact with the gum sheet, but can optionally be designed to advantageously or beneficially blend with a liquid anti-sticking agent on the gum sheet. Thus, the liquid anti-sticking agent on the gum sheet can be designed to partly or wholly solidify, after blending with the hot-melt ink applied to the gum sheet. In another embodiment, the liquid anti-sticking agent can be designed to solidify on the gum sheet prior to printing. Alternatively, a limited amount of the liquid anti-sticking agent can remain liquid under the surface markings formed by the printed hot-melt ink while allowing for sufficient adherence of the hot-melt ink to the surface of the gum sheet.

In one embodiment, for example, a thin layer of oil is applied to a gum mass to inhibit sticking to rollers used for sizing or calendaring a gum mass to form a gum sheet, and the gum sheet is subsequently printed on within thirty minutes of forming the gum sheet from the gum mass, wherein the gum sheet being subject to printing can be a continuous web or a gum sheet that is later scored or later scored and cut. In another embodiment, a particulate anti-sticking agent is applied to a gum sheet to inhibit sticking to rollers, wherein the total amount of dust (anti-sticking agent) that is applied to the gum sheet is limited in the first place, and prior to online printing. Thus, for example, a specified maximum level of dust can be used with a sizing (calendaring) operation, so that subsequent removal is unnecessary prior to printing. Alternatively, a limited amount or proportion of dust on the gum sheet prior to printing can be reduced by various techniques, as necessary to adapt the gum sheet for application of printed markings employing a hot-melt ink. Thus, it is optional prior to printing to de-dust the gum sheet, which can be in the form of a continuous sheet or “web.” De-dusting, or positive removal of at least some of the anti-sticking agent, can be accomplishing by one or more brushes, air guns, vacuum cleaning devices, and/or like means, in a coordinated action that reduces the dust level by a specified amount or proportion on the gum sheet prior to printing. In sum, the dusting can be matched to the capabilities of the printing system.

The printed markings made using the edible hot-melt ink can cover about 1% to 100% of at least one surface of the gum sheet, specifically 5% to 80% of the at least one surface, more specifically 20% to 65% of the at least one surface, and most specifically 30 to 60% of the at least one surface, wherein coverage includes the space between printed dots for print-on-demand inkjet printing. Thus, the coverage refers to visual coverage in the case of visual inks or transparent coverage in the case of transparent inks. In one embodiment, said surface area coverage applies to both opposing flat surfaces.

The printed markings on a gum sheet can be a single color or can be multicolored. Printed markings can be alternatively transparent. The color of the edible hot-melt ink can optionally be selected to be the same color but of greater or lesser intensity than that of the gum material. For example, various shades of blue or red can be applied to a colored gum sheet of a darker or lighter shade. Edible food grade hot-melt inks of various colors are commercially available, for example, from Markem Corp. (Keene, N.H.).

In an embodiment, the method comprises inkjet printing a single color hot-melt ink. In another embodiment, the method includes inkjet printing multiple color hot-melt inks. In an embodiment, the method includes inkjet printing using a single printing head, or multiple printing heads, wherein either the single printing head or multiple printing heads apply variously colored hot-melt inks.

The method can include a transport device for moving at gum sheet under a printing head at substantially the same mass flow or mass velocity as a gum mass being formed into a gum sheet.

The method can further include a detection device in operative communication with an inkjet printing system, wherein the inkjet printing system includes a print head that prints ink markings on a gum sheet after the detection device detects the gum sheet at a predetermined position. The detection device can comprise an automated photo-detector. Thus, an automated detection device can be used to detect the position of the gum sheet in order to align printing of desired ink markings at specified regions of the gum sheet. In one embodiment, an automated detection device uses one or more edges and/or score lines to detect the position of the gum sheet, or regions thereof, relative to the inkjet print head.

As indicated above, the present method can include controlling the amount of an anti-sticking agent on the gum sheet prior to inkjet printing a hot-melt ink onto a gum sheet. The method can include applying, onto the surface of the gum sheet to be printed on, an amount of a particulate or liquid anti-sticking agent that, at the time of printing, is present in an amount of 0.01 to 3 wt. %, specifically 0.05 to 2 wt. %, based on the total weight of the gum sheet and anti-sticking agent. A gum sheet can be optionally de-dusted prior to printing to remove a portion of a particulate anti-sticking agent. In one embodiment, one or more air guns, vacuum hoses, brushes, sponges and/or like means can be used for removing particulate anti-sticking agent. In another one embodiment, the amount of anti-sticking originally applied to a gum sheet can be preselected and controlled such that a corresponding preselected amount of anti-sticking agent is present on the gum sheet at the time of printing, specifically without requiring any supplemental means.

In one embodiment, the amount of particulate anti-sticking agent on the gum sheet when printed is up to 70 g/m², specifically up to 60 g/m², more specifically up to 52 g/m², most specifically up to 50 g/m², wherein both sides of the gum sheet have been coated with particulate anti-sticking agent. Depending on upstream and downstream operations and equipment, a minimum amount of particulate anti-sticking agent on the gum sheet can be used, for example, to prevent a gum sheet from sticking to steel rollers used to size a gum sheet. In one embodiment, the amount of particulate anti-sticking agent on the gum sheet when printed is at least 25 g/m², specifically up to 30 g/m², more specifically at least 32 g/m², most specifically at least 40 g/m². The endpoints of all ranges for amounts herein are independently combinable.

There is typically a greater amount of anti-sticking agent on the top surface than the bottom surface of the gum sheet, for example, the weight ratio of particulate anti-sticking agent on the top versus bottom surface of the gum sheet can be greater than 50:50, more specifically 60:40 to 75:25. Accordingly, in one embodiment, the amount of anti-sticking agent on the top surface of the gum sheet being printed is up to 50 g/m², specifically up to 45 g/m², more specifically up to 40 g/m², and most specifically up to 38 g/m². Similarly, in one embodiment, the amount of particulate anti-sticking agent on the gum sheet when printed is at least 15 g/m², specifically at least 17 g/m², more specifically at least 20 g/m², most specifically at least 24 g/m². A specific particulate anti-sticking agent is maltitol powder.

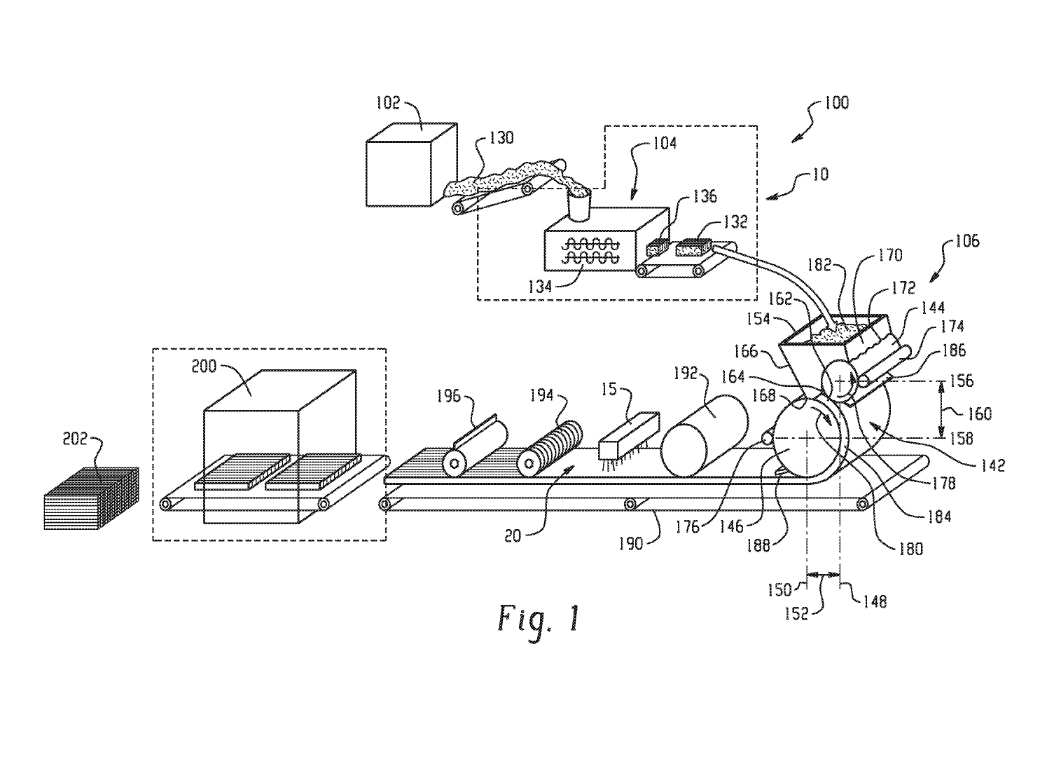

In one embodiment, a liquid anti-sticking agent (release agent) is applied to the gum sheet, not requiring removal prior to online printing. Specifically, there is no need for dusting material (particulate anti-sticking agent). In addition to this advantage, the rollers of the system shown in FIG. 1 can also be chilled (or heated in some embodiments) to provide cooling during deformation of the gum mass to a desired thickness and width. Therefore, the system according to some embodiments can form and cool or heat the gum mass to minimize the amount of anti-sticking agent that is needed to prevent the gum mass from adhering to rollers.

Accordingly, gum products manufactured according to some embodiments of the present disclosure can be structurally distinguishable from gum products produced using conventional gum lines, while producing chewing gum products having high quality surface markings printed online and, therefore, more efficiently, which printed markings can visually or otherwise please the customer when unwrapped and consumed, resulting in more aesthetically or sensorially pleasing chewing gum products.

In particular, FIG. 1 shows one embodiment of a gum manufacturing system 10 according to an exemplary embodiment that generally includes a gum mixing system 102, a gum forming or sizing system 106, an inkjet printing system 15, a scoring roller 194, and a dividing roller 196. The gum manufacturing system 10 is also shown here with an optional loafing machine 104, and a cooling tunnel 200. The scoring roller 194 and/or the dividing roller 196 can also be disposed downstream of the cooling tunnel 200.

An online inkjet printing system 15 applies a hot-melt ink composition, in the form of fine dots, onto a gum sheet which (in this case) is a continuous sheet 20 that has not yet been scored. The inkjet printing system 15 comprises a non-contact print head and associated hardware and software, as is commonly known in the art. As used herein, “non-contact printing” is the application of an ink composition to a substrate without the printing device touching a surface of the substrate to which the ink is applied. No part of the non-contact printing device need touch the surface of the gum sheet 20. Such non-contact with the gum material avoids the risk of damage to the gum surface or otherwise adversely affecting the surface of the gum sheet. Before continuing the discussion of the details of the gum manufacturing system 10, however, some general compositional information about gum will be provided.

Chewing gum is comprised, in large part, of components that are usually never swallowed, specifically gum base, which is the rubber-like chewing component. Chewing gum also comprises a consumed portion including sweeteners, flavors and the like, and can also include other candy or food product integrated therewith in layers or as ingredients. The gum base is relatively unique in food processing in that it introduces the material with a resiliency and elasticity relative to processing and also provides a relatively non-conductive or insulating material that does not transfer heat very well. This provides unique processing difficulties. Relative to processing, the temperature of the processed gum product greatly affects viscosity as well as other processing characteristics such as elasticity and resiliency.

Furthermore, different types of gum recipes can alter processing considerations to some extent, and there generally is a desire to run different gum recipes on the same equipment or lines. Some of the ingredients handle processing quite well. Other ingredients such as flavors can be subject to flash off due to heat, thereby diminishing the amount of flavor in the final consumable product. Other ingredients such as encapsulated sweeteners are sensitive to shear forces (e.g. due to substantial pressure, intense mixing, processing force and the like) and thus can be damaged during processing. These factors all provide different challenges relative to sizing the gum to a small bit size portion and conditioning of the gum for packaging in gum packaging. For purpose of understanding, some lexicography and typical gum composition components will be discussed next.

As used herein, “gum mass” and “gum sheets” includes finished gum, which includes gum base in addition to subsequent gum ingredients. Before further explaining systems and methods of manufacture, it is helpful to discuss the general composition of a typical finished gum material, which can be formed using embodiments of the systems and methods disclosed herein.

A “finished gum,” as used herein, will refer to a gum composition or structure that is generally ready for preparation to distribute as a product to the consumer. As such, a finished gum can still require temperature conditioning, forming, shaping, packaging and coating. However, the gum composition itself is generally finished. Not all finished gums have the same ingredients or the same amounts of individual ingredients. By varying the ingredients and amounts of ingredients, textures, flavor and sensations, among other things, can be varied to provide differing characteristics to meet the needs of users. The finished gum is exclusive of coatings or printed materials separate from the gum composition and exterior to its structure. As is generally well known, a finished gum generally includes a water soluble bulk portion, a water insoluble gum base portion, and one or more flavoring agents. The water soluble portion dissipates over a period of time during chewing. The gum base portion is retained in the mouth throughout the chewing process. A finished gum is typically ready for user consumption.

The finished gum will comprise a “finished gum base” which, as used herein, will refer to a gum structure that includes a sufficient combination of gum base ingredients that need only be combined with subsequent gum ingredients to form a finished gum. A finished gum base is a chewable visco-elastic material that includes at least a viscous component, an elastic component, and a softener component. For example, a typical gum base may include elastomer, at least some of the filler, resin and/or plasticizer, polyvinyl acetate, and a softener (such as an oil, fat or wax). Merely compounded elastomer without the addition of any softener, for example, would not be a finished gum base because it would not be considered useable in a finished gum structure because of its difficulty, if not impossibility, to chew.

Substantial and significant variations in a chewing gum composition can be envisioned by one of ordinary skill in the art. Some limited examples of minor variation are shown in Table 1.

TABLE 1

| | % by weight | | | | | | | |
|---|---|---|---|---|---|---|---|---|
| Component | Formula 1 | Formula 2 | Formula 3 | Formula 4 | Formula 5 | Formula 6 | Formula 7 | Formula 8 |
| Gum base* | 28-42 | 28-42 | 28-42 | 28-42 | 28-42 | 28-42 | 28-42 | 28-42 |
| Lecithin | 0.25 | 0.25 | 0.05 | 0.05 | 0.05 | 0.05 | 0.05 | 0.05 |
| Maltitol | 52-55 | 45-50 | 0 | 50-54 | 52-57 | 45-55 | 47-52 | 0 |
| Sorbitol | 0 | 0-10 | 0 | 0-5 | 0-5 | 5-10 | 0-5 | 0 |
| Lycasin ™ | 0 | 0 | 0 | 0.25 | 0.25 | 0.25 | 0.25 | 0 |
| Erythritol | 0 | 0 | 15-30 | 0 | 0 | 0 | 0 | 0 |
| Sugar | 0 | 0 | 20-40 | 0 | 0 | 0 | 0 | 30-55 |
| Corn Syrup | 0 | 0 | 2-15 | 0 | 0 | 0 | 0 | 2-15 |
| Flavors | 2.50 | 2.50 | 2.26 | 2.26 | 2.26 | 2.50 | 2.50 | 2.50 |
| Cooling | 0.08 | 0.08 | 0 | 0 | 0 | 0.08 | 0.08 | 0.08 |
| agent | | | | | | | | |
| Acidulants | 1.2 | 1.2 | 0 | 0 | 0 | 1.2 | 1.2 | 1.2 |
| Intense | 3.40 | 3.40 | 1.70 | 3.40 | 3.40 | 3.40 | 3.40 | 0 |
| sweetener | | | | | | | | |

*Gum base can include 3% to 11% by weight of filler such as, for example, talc, dicalcium phosphate, and calcium carbonate (the amount of filler and gum base comprises the “gum region composition”). For the above compositions, if a gum region composition includes 5% filler, the amount of gum base will be 5% less than the range recited in the table, i.e., from 23-37%)

In these examples, the compositions for the chewing gums are prepared by first combining talc, where present, with the gum base under heat at about 85° C. This combination is then mixed with the bulk sweeteners, lecithin, and sweetener syrups for six minutes. The flavor blends which include a pre-mix of the flavors and cooling agents are added and mixed for 1 minute. Finally, the acids and intense sweeteners are added and mixed for 5 minutes.

In addition to the various chewing gums mentioned above, it should be appreciated that the systems and methods can be used to form and size combinations of gum ingredients with other confectionery or candy ingredients, as disclosed in U.S. Patent Publication No. 2008/0166449, International Publication No. WO 2011/044373, and International Publication No. WO 2010/092480, the teachings and disclosures of which are hereby incorporated by reference in their entireties to the extent not inconsistent with the present disclosure.

Any conventional mixer can be used to mix a gum composition, although different types of mixers used can variously affect the characteristics of the feed material into the gum forming system 106 of FIG. 1. For example, different types of preconditioning and low shear extruders can be employed to modify raw mixer output and generate a regular stream and/or a continuous stream. In either event, it is contemplated that the gum forming system 106 is readily usable with a variety of mixing systems employed in the industry.

Specifically, a gum mixing system 102 can include a single mixer or multiple mixers equipped with various mixer components and/or mixer feeding systems for processing gum ingredients to make a gum mass. The one or more mixers can provide different types of mixing depending on the ingredients being mixed or the condition of the ingredients being mixed. Two primary types of mixing include distributive and dispersive mixing. Dispersive mixing is typically high shear mixing that breaks up individual ingredients and aggregations of ingredients within a composition into smaller pieces. Distributive mixing is typically lower shear mixing than distributive mixing and is used to distribute the individual ingredients throughout the composition to provide a more uniform composition. Dispersive and distributive mixing are more thoroughly described and discussed in U.S. Pat. No. 5,562,936, the teachings and disclosure of which are hereby incorporated in their entireties by reference thereto.

The mixers of the mixing system 102 can be a continuous mixer or a batch mixer. As used herein, “a continuous mixer,” which may also be referred to herein as a “continuous processor,” constitutes processing equipment in which the various ingredients used to prepare an effluent are fed substantially continuously into the equipment while those ingredients are being mixed and removed or ejected from the equipment. For example, in a continuous-mixer in the form of an extruder, ingredients are substantially continuously introduced through various upstream and downstream feed ports, all the while, the screws, blades, pins, paddles or other mixing elements continue to convey the mixture through the system, all the while mixing the same. At a downstream portion of the extruder, the wholly or partly combined downstream portion of the mass is ejected from the extruder by the force of the mass substantially continually or continually being conveyed. The ejection of the mass from the extruder can be facilitated by inclusion of an external or supplemental pump.

A continuous mixer can provide dispersive mixing, distributive mixing or a combination of both dispersive mixing and distributive mixing. For example, a continuous mixer in the form of an extruder can have all dispersive mixing elements, all distributive mixing elements, or a combination of dispersive mixing elements and distributive mixing elements. Due to the characteristics and requirements of mixing gum compositions, the dispersive mixing elements are typically upstream of the distributive mixing elements; however, continuous mixers according to the present process are not limited to that arrangement.

As used herein, “a batch mixer.” which may also be referred to herein as a “batch processor,” constitutes processing equipment used to prepare a composition wherein once the composition is prepared the composition is ejected from the equipment all at once or at least discrete non-continuous portions of the composition will be ejected at intermittent intervals, but the composition is not continuously ejected during mixing. Typically, individual ingredients or portions of the individual ingredients used to prepare the composition are fed into the device substantially all at one time or in a predetermined temporal sequence in discrete amounts. Individual ingredients added to a batch mixer can be added at different times throughout the mixing cycle such that some ingredients have a residence time substantially equal to the entire length of the mixing cycle while other ingredients have a residence time for only a fraction of the entire length of the mixing cycle. Further, individual ingredients that are used for different purposes throughout the mixing cycle can have different discrete portions of the ingredient added at different times throughout the mixing process. For example, one ingredient can be used to facilitate compounding elastomer as well as can be used as a bulking agent. Such an ingredient can have a first portion added at the beginning of the mixing cycle such that it has a residence time equal to the entire mixing time while a second portion of the same ingredient can be added later in the mixing cycle such that the second portion has a residence time less than the entire mixing time.

A batch mixer can typically provide either dispersive mixing or distributive mixing. A batch mixer used in practicing the present process can be configured to provide both dispersive and distributive mixing. For example, it is contemplated that a kettle mixer that includes internal blades could be configured to shift between dispersive and distributive mixing by modifying the pitch or orientation of the blades. Alternatively, the kettle mixer can include multiple sets of blades, such that one set is configured for dispersive mixing while another set is configured for distributive mixing. It is contemplated the mixer would most likely only use one set of the blades at a time to provide one type of mixing at a time.

In some embodiments, the gum mixing system 102 can include one continuous mixer or one batch mixer. In other embodiments, the gum mixing system 102 can include one or more continuous mixers and/or one or more batch mixers arranged in series and/or parallel. Various parallel and series mixing system arrangements are described in U.S. patent application Ser. Nos. 12/338,428 and 12/338,682, which are assigned to the present assignee, the disclosures of which are hereby incorporated by reference in their entireties.

Referring more specifically now to the embodiment shown in FIG. 1, a gum structure output 130 from the gum mixing system 102 can be generally irregular or otherwise produce a non-uniform thickness of material, either in the transverse or (by use of corresponding rollers) the machine direction. Depending on its formulation, the non-uniform gum structure output 130 can be fed as a gum mass 182 directly into the gum forming system 106 to form a substantially flat gum sheet 184 having a desired uniform thickness. However, as shown in the embodiment of FIG. 1, the non-uniform gum structure output 130 is further processed into a somewhat uniform shape or width prior to entering the gum forming system 106 as the gum mass 182.

Specifically, in the embodiment shown in FIG. 1, the gum structure output 130 is preformed into loaves 132 before being further formed into a continuous web or sheet 184 having a desired width and thickness in the gum forming system 106. As such, this embodiment is shown with an optional loafing machine 104 upstream of the forming system 106. The loafing machine 104 is shown as a low-shear extruder 134. The extruder 134 forces the gum structure output 130 through a forming die, thereby forming a loaf output 136 that can be periodically cut off into separate loaves 132 (alternatively a continuous stream of a generally uniform size can be provided without cutting into loaves). The loaves 132 can have a slight parallelogram shape or be of slight shape variations in width and length, but the thickness of the individual loaves 132 is, in this specific embodiment, between about 12 and 127 mm thick (vertically) with the length and width being between about 100 mm and 460 mm. Typically, the output orifice of loafing extruder 104 is relatively large enough so as to be considered “low shear” as opposed to sizing type extruders of the prior art. As a result, a maximum thickness of the output is greater than about 25 mm (e.g. between 25-50 mm) and/or has a width, in the exemplary embodiment, of less than 460 mm. The shape need not be perfectly rectangular (or trapezoidal). Such a loafing machine system 100 is disclosed in U.S. patent application Ser. No. 12/352,110, which is assigned to the present assignee, the disclosure of which is hereby incorporated by reference in its entirety. Forming the gum structure output 130 into loaves 132 can provide flexibility to a gum line. For example, the downstream forming process can be performed at a later time, or the loaves can be transferred to a different location for further processing or conditioning.

The loaves 132 are then transferred to the gum forming system 106, wherein the loaves 132 can be compressed into a desired thickness. Alternatively, and as discussed previously, the gum structure output 130 can be fed directly into the gum forming system 106 without being formed into the loaves 132. Yet in a different embodiment, the mixing system 102 can include an extruder equipped with a forming die having a large output orifice (which minimizes shear stress within the forming die and temperature in the resulting rope) to output a gum rope having a somewhat uniform shape. For example, the forming die can be configured to output a continuous web or rope of gum having a thickness greater than about 20 mm. The forming die can be adjustable to produce various widths of the continuous web according to a desired width of the gum sheet.

In the exemplary embodiment of FIG. 1, the forming station 106 for producing a continuous sheet 20 includes a pair of moving rollers 142. Specifically, such rollers can be used for forming a gum structure/mass into a continuous web or sheet having a desired thickness and width, while optionally imparting temperature control to the gum at the same time. The forming system 106 can form the gum mass into a gum sheet including a desired width and thickness with a limited variance. Further, the exemplary forming station 106 shown in FIG. 1 can also eliminate a need for powder dusting material, as discussed further below.

The pair of moving rollers 142, in this embodiment, including an upper roller 144 and a lower roller 146. The rollers 142 are externally driven, for example by an operably coupled motor. In an exemplary embodiment, each of the rollers 142 is provided with a motor, such that a rotational speed of each of the rollers 142 can be controlled independently.

A hopper 154 can be used for upstream surge control, capacity and feed control. The hopper 154 constrains, accumulates, and feeds the gum mass 182 into an inlet region 164 generally between the set of rollers 142. The hopper 154 can alternatively be configured to receive the gum structure output 130, the loaves 132, and/or the somewhat uniform web of gum structure having various web widths, and accumulate the received gum as the non-uniformly shaped gum mass 182. The width of the inlet region 164 of the hopper 154 can be adjusted according to a desired width of the gum sheet 184. In one embodiment, the upper and lower rollers 144, 146 are configured to accommodate the gum sheet 184 at a width of between about 25 mm to 1 m, or perhaps more. It may be desirable to have a wider sheet of the gum of greater than about 0.6 m in width so as to be able to provide a substantial gum mass volume that can operate at slower speeds while generating sufficient output.

The gum mass 182 is guided by the upper roller 144 toward the lower roller 146, wherein the counter rotating upper roller 144 and lower roller 146 pull the gum mass 182 between the rollers 144, 146 to form and size the gum mass 182 into the gum sheet 184. In other embodiments, the hopper 154 can include more than a pair of feeding rollers to further facilitate feeding and widening of the gum mass 182 in the hopper 154.

The upper roller 144 and the lower roller 146 are arranged such that a spacing or gap 162 is formed between the rollers 144, 146, which allow the gum to pass between the rollers. The pair of rollers 144, 146 and the spacing 162 are configured to apply a compressive or deforming force onto the gum mass 182 to form the gum sheet 184 having a generally uniform thickness corresponding to the spacing 162. The term “a generally uniform thickness” of the gum sheet 184 is used broadly herein to describe a transverse cross-sectional web shape of the gum sheet 184 upon exiting the pair of rollers 142, whereas the “transverse direction’ is perpendicular to the direction of movement of the gum sheet and the “machine direction” applies to the direction of movement of the gum sheet.

Thus, the upper roller 144 and the lower roller 146 are configured to counter rotate to pull the gum mass 182 through the gap 162. This pulling or dragging of the mass 182 by the rollers 144, 146 results in a drag flow of the gum through the gap 162. In the embodiment shown in FIG. 1, the upper roller 144 rotates in a counter clockwise direction 178, while the lower roller 146 rotates in a clockwise direction 180. As the gum mass 182 is pulled through the minimum distance of the gap 162, which can be as narrow as 0.1 mm, the gum mass 182 mass is deformed between the rollers 144, 146, with this deforming/sizing being substantially extensional.

The rollers 144, 146 in the embodiment of FIG. 1 eliminates dusting of the gum with talc or other particulate anti-sticking agent that are used in more conventional rolling reduction operations. This can avoid the need for dust collection equipment as used in traditional rolling and scoring lines; and can also be used to create a more aesthetically pleasing product that has more vibrant colors as dusting operations can dull the final product color. In particular, the absence of the dusting with anti-stick agent allows quality printing with a hot-melt ink, as further discussed below.

Specifically, in this exemplary embodiment the upper roller 144 can be equipped with an oiling roller 174 to lubricate the upper roller 144 with a release agent such as food quality vegetable or mineral oil, which acts to prevent sticking of the gum to the rollers 142. Similarly, the lower roller 146 can be equipped with an oiling roller 176 to lubricate the lower roller 146. Therefore, the gum forming system 106 can eliminate the need of powder releasing agents such as talc or a polyol. Although each of the rollers 144, 146 is provided with the oiling roller 174, 176 in this embodiment, in other embodiments only one of the upper and lower rollers 144, 146 may be provided with one oiling roller, or neither of the rollers 144, 146 may be provided with an oiling roller when the rollers 144, 146 have a sufficiently low surface tension or adhesion to release the gum sheet 184 without aid of a releasing agent, as long as the tackiness of the gum sheet 184 is sufficiently limited for subsequent scoring, cutting and packaging processes. Further, other lubricating systems, for example, a spray bar or a dipping basin can be used to apply a suitable liquid lubricator. As shown in FIG. 1, the roller 146 is provided with a scrapper 188 downstream of the gap 162 to detach the gum sheet 184 from the surface of the roller 146 onto a conveyor belt 190.

It should be appreciated that at least a portion of the above mentioned release agent can desirably remain with the gum sheet 184 after the gum sheet 184 has passed between and contacted the sizing rollers 142. After being released from rollers 142 including lubricating systems such as the oiling rollers discussed above, the sheet 184 can subsequently include, for example, 0.1 wt. % to 3 wt. % of the oil applied, with most of the percentage of oil remaining with the sheet 184 being located at or near one or both surfaces of the gum sheet 184. This liquid release agent can desirably affect a flavor profile of the gum sheet 184 and can be a vegetable fat from a vegetable such as, but not limited to, soybean, cotton seed, corn, almond, peanut, sunflower, sal, rapeseed, olive, palm, palm kernel, illipe, shea, and coconut, and/or at least one of cocoa butter, dairy fat, and polyethylene glycol (PEG). In addition, the release agent can include at least one flavor agent such as but not limited to synthetic flavor oils, natural flavoring aromatics and/or oils, oleoresins, extracts derived from plant, leaves, flowers, fruits, spearmint oil, cinnamon oil, oil of winter green, peppermint oil, clove oil, bay oil, anise oil, eucalyptus oil, thyme oil, cedar leaf oil, oil of nutmeg, allspice oil, oil of sage, mace oil, oil of bitter almonds, cassia oil, citrus oils including lemon, orange, lime, grapefruit, vanilla, fruit essences including apple, pear, peach, grape, strawberry, raspberry, blackberry, cherry, plum, pineapple, apricot, banana, melon, tropical fruits, mango, mangosteen, pomegranate, papaya, honey lemon, cinnamyl acetate, cinnamaldehyde, citral diethylacetal, dihydrocarvyl acetate, eugenyl formate and mixtures thereof.

Still further, a release agent that changes from a liquid at processing temperature (i.e. during sizing at the rollers 142) to solid at room temperature or the temperature of the gum at the time of printing with hot-melt ink can also be desirable. Accordingly, and in an exemplary embodiment, molten solid fats such as palm oil or coconut oil can be applied at 30° C.-40° C. as a liquid release agent on forming drums 142, and solidify on the gum sheet 184 as gum sheets are cooled (for instance below 20° C.). Similarly, polyethylene glycol (PEG) of molecular weights 1000, 1200, 3000 up to 6000 can be applied at 40° C. to 60° C. as a release agent on forming drums 142, and also solidify on the gum sheet 184 as gum sheets are cooled. Solidification of these materials on the gum sheet 184 provides a barrier between stacked gum sheets, thereby preventing gum sheets from sticking to each other during conditioning and packaging operations which are normally carried out below 25° C.

As shown in FIG. 1, the upper roller 144 of FIG. 1 can also be provided with a scraper 186 near the spacing 162 to ensure the gum sheet 184 detaches from the surface of the upper roller 144, thereby facilitating the gum sheet 184 traveling on the lower roller 146. The lower roller 146 can further be provided with a scrapper 188 near the bottom of the lower roller 146 to detach the gum sheet 184 from the surface of the lower roller 146 onto a conveyor belt 190. In some embodiments, the conveyor belt 190 can be adapted for cooling or heating to further condition the continuous sheet of gum sheet 184. The conveyor belt 190 can be optionally chilled to provide additional cooling to the gum sheet 184.

The forming system 106 of FIG. 1 can also further include a compression roller 192 wherein upon exiting the pair of rollers 142, the conveyor belt 190 moves the gum sheet 184 toward the compression roller 192. The compression roller 192 is arranged preferably about 0.5 m to 3 m from the lower roller 146, specifically about 1 m to 1.5 m. The compression roller can be used to remove surface imperfections, kinks and can further reduce the thickness of the gum sheet 184. However usually any further reductions can be limited to 10% or less, thereby achieving the advantage that progressive rolling reductions are not necessitated. In this embodiment, the pair of rollers 142 can be configured to output the continuous gum sheet 184 having a thickness within 10% of a desired final thickness of the final gum product, and the optional compression roller 192 is configured to adjust the thickness of the gum sheet 184 by less than 10%. The final thickness of the gum product can be substantially flat or can include contours, embossing, or other three-dimensional surface structure. Specifically, the gum sheet is formed into a substantially final thickness of the gum product (either in the presence of absence of optional compression roller 192 following the forming station 106), which substantially final thickness can be within 10 percent of the thickness of the corresponding portion of the formed gum sheet, more specifically within 5 percent, more specifically within 2 percent. The thickness of the gum sheet during manufacture can change slightly, for example, due to temperature changes or the like. In an embodiment, the substantially final thickness of the formed gum sheet is obtained before online printing and after all contact compression, for example, by calendaring or sizing rollers.

For example, in an implementation wherein the desired final thickness of a stick gum product is 2.0 mm, the spacing 162 of the pair of rollers 142 can be adjusted such that the continuous sheet gum sheet 184 has a generally uniform thickness of about 2.1 mm. Optionally, one or more further rollers such as compression roller 192 can be arranged relative to the conveyor belt 190 to reduce the generally uniform thickness to about 2.0 mm, prior to printing. Depending on a formulation of the gum being formed, the gum sheet formed through a pair of rollers can expand upon exiting the pair of rollers, thereby resulting in an increased thickness of the gum sheet. For example, a gum sheet can be formed through a pair of rollers having a spacing of 3 mm, wherein the gum sheet is compressed down to a thickness of about 3 mm. Upon exiting the pair of rollers, the gum sheet can expand to a thickness of about 3.3 mm. In such embodiment, a subsequently arranged compression roller can be configured to apply sufficient pressure to compress the expanded gum sheet layer back down to 3 mm. In other embodiments, a gum sheet can shrink upon exiting the pair of rollers. For example, a gum sheet can shrink by about 10% in its thickness upon exit. In such embodiment, the spacing can be set to about 10% or more greater than a desired final thickness. For example, wherein the final desired thickness of the gum sheet thickness is 3 mm, the pair of rollers can be set to have a spacing of about 3.5 mm. The gum sheet is compressed down to a thickness of about 3.5 mm between the pair rollers and shrinks upon exiting the pair of rollers to a thickness between about 3.1 mm-3.2 mm. The shrunken gum sheet is then further compressed via a subsequent compression roller to the desired final thickness of about 3 mm. In some embodiments, the compression roller 192 can be configured to be a chilled roller to provide additional cooling.

Following the roller 192 in the embodiment of FIG. 1, the system 10 further includes an inkjet printing system 15, as mentioned above. The online printing can be located at an advantageous time and position during online manufacturing the gum products. Specifically, the online printing of a gum sheet can be conducted during a preselected time after it is finally formed in terms of transverse thickness (either from roller 92 or in the absence of roller 92, rollers 142) and within a preselected temperature range of the surface of the gum sheet to be printed.

Specifically, in one embodiment of the method, hot-melt ink is applied to the top surface of a gum sheet (either a continuous sheet or individual cut sheets) within 30 minutes, specifically within 15 minutes, more specifically within 10 minutes, most specifically within about 5 minutes of finally forming the gum sheet, which gum sheet can still have a warm and soft texture. Thus, as mentioned above, the online printing can be conducted prior to final conditioning of the gum, for example prior to an optional cooling tunnel, while the gum is still relatively warm, specifically above room temperature.

In particular, the continuous sheet of gum 20 can have a temperature from 20° C.-60° C. when entering the printing system, wherein it is printed with the preselected markings. In one embodiment, the continuous sheet of printed gum is then scored and/or cut to sheets or strips.

According to one exemplary embodiment, the temperature of the gum to be printed can be considered in context of the manufacturing system 10 as follows. Thus, the finished gum 182 in the hopper 154 can have an average temperature between 40° C.-60° C. The rollers 144, 146 can be equipped with temperature control mechanisms, wherein a heating/cooling fluid can be circulated to heat the rollers 144, 146. In the exemplary embodiment, the fluid temperature is controlled to maintain the rollers 144, 146 at a surface temperature between 40° C.-60° C. Presumably, the temperature of the fluid is correspondingly between about 40° C.-60° C. Thus, the rollers 144, 146 can facilitate forming of a continuous sheet of gum 184 and control a local viscosity of the gum such that the gum can be formed to a desired thickness and width and carried by the lower roller 146 to the conveyor belt 190. Similarly, the continuous gum sheet 184 exiting the set of rollers 144, 146 can have a temperature at the surface in contact with the lower roller 146 between 35° C.-60° C. and at the surface not in contact with the lower roller 146 between 35° C.-60° C. Depending on a thickness and formulation of the continuous gum sheet 184, a temperature gradient may exist throughout the thickness of the gum, so that temperatures refer to the surface of the gum sheet.

Thus, online printing can be carried out at a temperature of 20° C. or above, or about 20 to 60° C., specifically 25 to 40° C. more specifically 28 to 36° C. most specifically 30 to 34° C. The temperature of subsequently scored gum sheets will typically be lower, having a lower temperature range of between 10 to 40° C. The temperature gradient throughout the thickness of the gum sheet is preferably between plus or minus 0° C.-5° C. before entering the optional cooling tunnel 200, as described below.

Thus, a coordinated process design exists between the temperature of gum sheet to be printed and the melting temperature of a hot-melt ink applied by the inkjet printing system 15 of FIG. 1, in which the system comprises an inkjet print head that selectively deposits a jettable hot-melt ink composition, held at a specified waiting temperature, for example about 125° C. to obtain a jettable viscosity, onto the gum sheet to be printed using a drop-on-demand printing system. Such printing can advantageous provide a high resolution pattern or other markings, in which the drop-on-demand printing system forms discrete droplets of ink that are ejected from an array of nozzles past which the gum sheet passes, the nozzles being activated at the desired frequency and in the desired order to form the desired markings on the gum sheet. The hot-melt ink under pressure can flow to the nozzles via valving means that are actuated under the control of a computer or the like to allow ink to flow to the required nozzle to eject a droplet from that nozzle.

The inkjet printing system 15 of FIG. 1 can include one or more jetting print heads in fluid communication with one or more or more reservoirs by way of channels. For example, a printing device can be configured with one or a plurality of reservoirs. Optionally, a plurality of reservoirs can contain edible hot-melt ink composition of various colors (such as cyan, magenta, yellow, and black or white) in order to provide multiple color images. The inkjet printing system can, of course, be configured with more or less reservoirs for more or less colors as desired. Each jetting print head in the inkjet printing system typically includes a plurality of jetting nozzles as is commonly known in the art. For example, a jetting print head can include from 10 to 50, 50-100, 100-500, 500-1000, or 1000-5,000 or more individual nozzles or jets. Jetting print heads can be arranged in any desired manner to deliver a hot-melt ink composition onto a continuous or non-continuous gum sheet. For example, a jetting print head can have nozzles arranged in a single line. Alternatively, jetting heads can have nozzles arranged in a series of parallel lines.

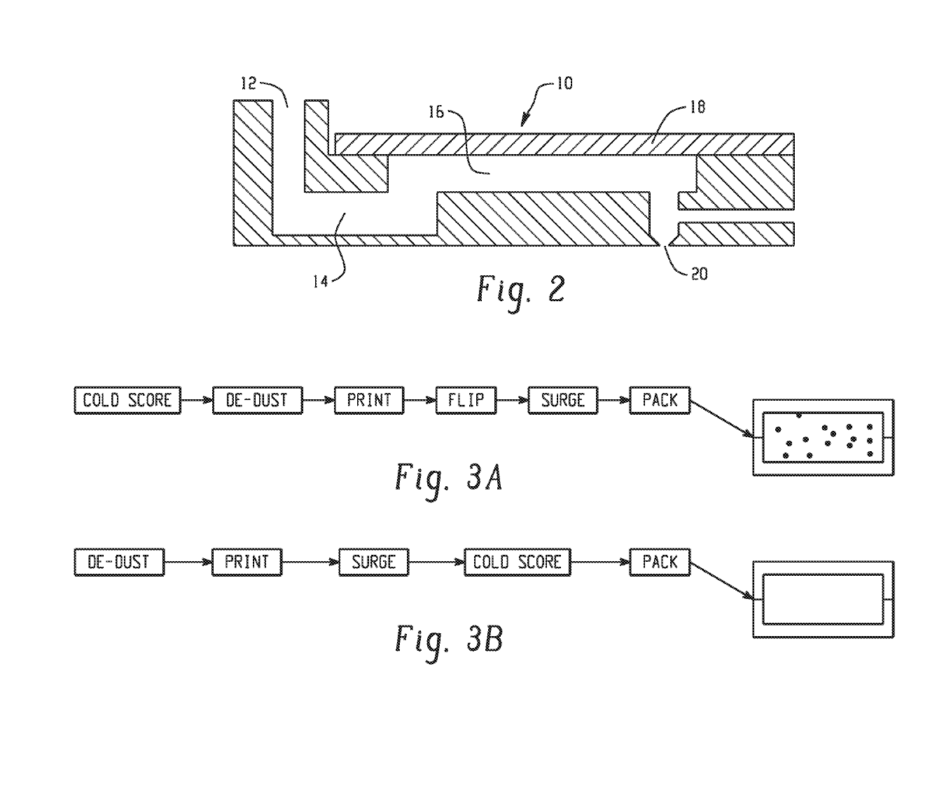

An embodiment of an inkjet print head 10 for use in the inkjet printing system 15 of FIG. 1 is shown, in cross-section, in FIG. 2. The inkjet print head 10 comprises a series of individual nozzles 20. Although shown as a single print head in FIG. 1, it is to be understood that, depending on the width of the gum sheet, a plurality of print heads may extend transversely across the print head in order to be able to print over the entire width of the gum. For example, a printing head can have a width of 2 to 4 inches or more and several print heads (for example, 2 to 5) may extend transversely, in adjacent sequence, across the width of the gum sheet for printing, which can vary from 10 mm to 1 meter. In one embodiment, for example, separate gum sheets can be 9 to 18 inches in width and 14 to 18 inches in length.

In the embodiment of FIG. 1, a conveyor or other transport device moves the gum sheet under an inkjet print head 10. Thus, the gum sheet can move with respect to a printing head while being printed. A print head 10 can be aligned essentially perpendicular to the gum sheet to be printed. Alternatively, the print head can be positioned at an angle to a transverse line, for example at an angle of 0 to 60 degrees, specifically between 10 and 30 degrees in one embodiment, in order to increase the density or resolution of printing.

Specifically, according to the embodiment of FIG. 2, a typical print head 10 includes a fill port 12 which can be connected to a reservoir for the hot-melt ink composition, a membrane cavity 14 or the like for removing air bubbles form the melted composition, a pumping chamber 16, a piezoelectric transducer (PZT) 18, and a nozzle orifice 20. The ink can be placed into the print head through the fill port 12. The ink, after passing through the membrane cavity 14 where the ink is degassed, can flow into the pumping chamber 16. The print head is heated, so that ink just prior to being ejected as fine droplets, by activation of the PZT, from the inkjet print head onto the gum sheet as it passes by the print head. Upon contacting the sheet, the liquid ink can rapidly cool and solidify on the surface of the relatively cooler gum sheet, freshly formed and which can still be warmed above room temperature. Specifically, the hot-melt ink solidifies within 10 seconds of contact, more specifically within 5 seconds, for example within about 1 second, as can determined by touching the markings with a finger and testing for the absence of smudging or smearing. The hot-melt ink composition can be formulated to be compatible with the gum material of the gum sheet in order to provide a high resolution ink markings that adheres to the surface thereof.

The inkjet printing system 15 in the embodiment of FIG. 1 is located after optional calendaring roller 192, specifically prior to cutting roller 195 and scoring roller 194, in order to print ink markings onto gum sheet 20 downstream of extruder 134 and opposing rollers 142 and 144, which forming a flat gum sheet on which is applied an anti-sticking agent. The inkjet printing system 15 can print a predetermined amount of hot-melt ink onto discrete portions of the gum sheet to obtain preselected ink markings.

An inkjet printing system employing hot-melt ink can be purchased from various commercial vendors. For example, Integrity Industrial Ink Jet Integration, LLC, a New Hampshire corporation located at 16 Airpark Road, West Lebanon, N.H. 03784 (“Integrity”) supplies a Spectra® Brand (Merlin® model) with one print head able to achieve a variety of resolutions (expressed as dots-per-inch or “dpi”). Other commercial companies offer hot-melt inkjet systems for use in a variety of industrial purposes, as will be appreciated by skilled artisans in the art. Such inkjet printing systems have been used in various industrial settings and can be readily adjusted for use in the present context by one of ordinary skill.

As noted above, the method for forming marks on the flattened gum using the inkjet printing system 15 comprises heating an edible hot-melt ink including optionally a colorant to a temperature sufficient to liquefy the ink, and then selectively applying the ink to the surface gum sheet. As previously mentioned, hot melt inks are solid in a range including room temperature, and liquid at a selected temperature range above room temperature. During printing, the ink is heated until it becomes liquid, and is then ejected through a print head onto the gum substrate. The ink then solidifies on the substrate.

The hot-melt ink can be selected so that its melting temperature is greater than the temperature of the gum sheet to be printed during manufacture. Thus, the hot-melt printing is designed to rapidly, specifically more or less immediately “set.” due to a rapid phase change from liquid ink in the printer head to a solid on the surface of the gum, so that the ink is dry to touch with within 10 seconds after application to a gum sheet.

The hot melt ink is formulated using edible components. Because the inks are made with edible ingredients, the inks can be in compliance with the Federal Food, Drug, and Cosmetic Act, and all other applicable food additive regulations. In addition to being edible, the inks have a number of properties that make them suitable for use on gum. For example, the hot-melt inks can be formulated such that they can adhere to the gum while it is still warm and/or soft. The hot-melt inks can be formulated such that markings made with the inks do not deteriorate in quality and can remain legible if desired, even after being subjected to the later conditioning and packaging.

Specifically, the ink composition is a hot-melt ink that can be a wax-based ink, optionally comprising one or more edible pigments or dyes. Alternatively, the edible ink can be non-pigment and/or non-dye containing in terms of the color of the ink. An ink can be transparent if desired.

In an embodiment, the edible hot-melt ink composition can be a wax-based edible ink. A wax-based-ink can include a dye dispersed or dissolved in a fat, wax, or oil. The wax can include any food grade wax, including but not limited to, microcrystalline wax, paraffin, and natural or synthetic wax. The ink can contain enough wax that the ink, as a whole, is a hot melt material. The ink can also contain combinations of waxes. In one embodiment, the ink contains about 50% to about 99% by weight wax. Examples of waxes include: stearic acid; succinic acid; beeswax; candelilla wax; carnauba wax; alkylene oxide adducts of alkyl alcohols; phosphate esters of alkyl alcohols; alpha alkyl omega hydroxy poly (oxyethylene); allyl nonanoate; allyl octanoate; allyl sorbate; allyl tiglate; rice bran wax; paraffin wax; microcrystalline wax; synthetic paraffin wax; synthetic paraffin and succinic derivatives; petroleum wax; synthetic petroleum wax; cocoa butter, diacetyl tartaric acid esters of mono and diglycerides; mono and diglycerides; alpha butyl omega hydroxypoly(oxyethylene)poly(oxypropylene); calcium pantothenate; fatty acids; organic esters of fatty acids; calcium salts of fatty acids; mono & diesters of fatty acids; sucrose fatty acid esters; calcium stearoly-2-lactylate; Japan wax; lanolin; glyceryl hydroxydecanoate; glyceryl hydroxydodecanoate; oxidatively refined montan wax fatty acids; polyhydric alcohol diesters; oleic acids; palmitic acid; d-pantothenamide; polyethylene glycol (400) dioleate; polyethylene glycol (MW 200-9,500); polyethylene (MW 200-21,000); oxidized polyethylene; polyglycerol esters of fatty acids; polyglyceryl phthalate ester of coconut oil fatty acids; shellac wax; hydroxylated soybean oil fatty acids; stearyl alcohol; and tallow and its derivatives.

The ink can include a resin. The resin (polymer) can provide the ink with a desired viscosity, thermal stability, flexibility, and adhesion properties. The ink should include enough resin to achieve the desired viscosity, stability, flexibility, and adhesion. Preferably, the ink contains about 0% to about 50% by weight resin, and more preferably contains about 30% to about 50% by weight resin.

Examples of resins include acacia (gum arabic); gum ghatti; guar gum; locust (carob) bean gum; karaya gum (sterculia gum); gum tragacanth; chicle; highly stabilized rosin ester; tall oil; manila copais; corn gluten; coumarone-indene resins; crown gum; damar gum; p, alpha-dimethylstyrene; gum elemi; ethylene oxide polymer and its adducts; ethylene oxide/propylene oxide copolymer and its adducts; galbanum resin; gellan gum; ghatti gum; gluten gum; gualac gum; guarana gum; heptyl paraben; cellulose resins, including methyl and hydroxypropyl; hydroxypropyl methylcellulose resins; isobutylene-isoprene copolymer; mastic gum; oat gum; opopanax gum; polyacrylamide; modified polyacrylamide resin; polylimonene; polyisobutylene (min. MW 37,000); polymaleic acid; polyoxyethylene derivatives; polypropylene glycol (MW 1200-3000); polyvinyl acetate; polyvinyl alcohol; polyvinyl polypyrrolidone; polyvinyl pyrrolidone; rosin, adduct with fumaric acid, pentaerythritol ester; rosin, gum, glycerol ester; rosin, gum or wood, pentaerythritol ester; rosin, gum or wood, partially hydrogenated, glycerol ester; rosin, gum or wood, partially hydrogenated, pentaerythritol ester; rosin, methyl ester, partially hydrogenated; rosin, partially dimerized, glycerol ester; rosin, partially hydrogenated; rosin and rosin derivatives; rosin, polymerized, glycerol ester; rosin, tall oil, glycerol ester; rosin, wood; rosin, wood, glycerol ester; purified shellac; styrene; styrene terpolymers; styrene copolymers; sucrose acetate isobutyrate; terpene resins, natural and synthetic; turpentine gum; vinylacetate; vinyl chloride-vinylidene chloride copolymer; zanthan gum; and zein.

The ink can include a colorant or dye, which provides color to the ink. If an ink is to be used on a white or light-colored gum, it is desirable for the ink to have a dark color, for better legibility of the markings. If an ink is to be used on a dark-colored gum product, it may not be necessary to include a colorant in the ink. The ink preferably contains a sufficient amount of the colorant that the ink has color, but not so much as to interfere with other desirable qualities, such as hot melt qualities or viscosity. An ink can contain about 0.1% to about 20% by weight colorant, specifically about 1% to about 10% by weight colorant.

The food grade colorants can include synthetic colorants, natural colorants, or combinations thereof. Examples of colorants include beta carotene; b-apo-8′-carotenal; canthaxanthin; astaxanthin; brown algae extract; red algae; red algae extract; allspice oleoresin; FD&C Green no. 3; FD&C Green no. 3, aluminum lake; FD&C Green no. 3, calcium lake; FD&C Blue no. 1; FD&C Blue no. 2; FD&C Blue no. 1, aluminum lake; FD&C Blue no. 2, aluminum lake; FD&C Blue no. 1, calcium lake; FD&C Blue no. 2, calcium lake; FD&C Red no. 40; FD&C Red no. 40, calcium lake; FD&C Yellow no. 6; FD&C Yellow no. 5, aluminum lake; FD&C Yellow no. 5, calcium lake; FD&C Yellow no. 6, aluminum lake; FD&C Yellow no. 6, calcium lake; iron oxide; citrus red no. 2; titanium dioxide; turmeric oleoresin; ultramarine blue; carmine; caramel; channel black; FD&C Green no. 3; FD&C Red, no. 3; ED&C Yellow, no. 6; Ponceau 4R; quinoline yellow; patent blue V; Green S; Brown HT; brilliant black BN; carmoisine; amaranth; erythrosine late; amaranth lake; Ponceau 4R lake; and carmoisine lake. Specifically. FD&C Blue no. 1 and FD&C Red no. 40 colorants can be selected.

Natural dyes can include turmeric oleoresins, cochineal extracts, gardenia extracts, and natural colors derived from vegetable juices, for example, beet extract, grape skin extract, and chlorophyll containing extracts (e.g. nettle extract, alfalfa extract and spinach extract). To achieve a desired color tint or shade, the colored liquids can include mixtures of more than one synthetic and/or natural food grade dye.

The ink can include a stabilizer, which inhibits oxidation of the ink components. Sufficient stabilizer should be included to inhibit oxidation, but not so much should be included that the other properties of the ink are adversely affected. An ink can include, for example, about 0.1% to about 2% by weight stabilizer. Examples of stabilizers include butylated hydroxyanisole (BHA); butylated hydoxytoluene (BHT); propyl gallate; tert-butyl hydroquinone (TBHQ); ethylenediaminetetraacetic acid (EDTA); methyl paraben; propyl paraben; benzoic acid.

The ink can include a dispersant and/or a surface tension modifier. A sufficient quantity of these optional ingredients can be included in the ink to provide the desired property, e.g., the desired surface tension. The ink preferably includes about 0.5% to about 5% by weight dispersant or surface tension modifier, and more preferably contains about 0.2% to about 1% by weight dispersant or surface tension modifier. An example of a dispersant and/or surface tension modifier is lecithin.

Additionally, the ink can include other conventional hot melt ink ingredients such as oils, flexibilizers, plasticizers, flavorings, micronutrients, buffering agents, antimicrobial agents, and other additives. The ink composition can also include adhesion enhancers such as a film-forming resin. The oils, flexibilizers, and plasticizers can reduce the viscosity of the inks and a sufficient quantity of these optional ingredients can be included in the ink to provide the desired viscosity.

Examples of oils, flexibilizers and plasticizers include glycerin; lecithin and modified lecithins; agar-agar; dextrin; diacetyl; enzyme modified fats; glucono delta-lactone; carrot oil; chincona extract; rapeseed oil; pectins; propylene glycol; peanut oil; sorbitol; acetophenone; brominated vegetable oil; polyoxyethylene 60 sorbitan mono stearate; olestra; castor oil; oiticia oil; 1,3 butylene glycol; coconut oil and its derivatives; corn oil; substituted benzoates; substituted butyrates; substituted citrates; substituted formates; substituted hexanoates; substituted isovalerates; substituted lactates; substituted propionates; substituted isobutyrates; substituted octanoates; substituted palmitates; substituted myristates; substituted oleates; substituted stearates, distearates and tristearates; substituted gluconates; substituted undecanoates; substituted behenates; substituted succinates; substituted gallates; substituted heptanoates; substituted phenylacetates; substituted cinnamates; substituted 2-methylbutyrates; substituted tiglates; corn syrup; isoparaffinic petroleum hydrocarbons; mineral oil; glycerin; mono- and diglycerides and their derivatives; olibanum oil; opopanax oil; peanut oil; polysorbates 20, 60, 65, 80; propylene glycol mono- and diesters of fats and fatty acids; epoxidized soybean oil; hydrogenated soybean oil; sperm oil; and hydrogenated sperm oil.

The ink composition can also include an organoleptic component and/or an active agent as will be described in detail below. An organoleptic component can be any component that is perceptible by the senses. Thus, organoleptic component can be any component that can be perceived or detected visually, by touch (i.e., by hand, tongue, or mouth feel), taste, and/or by smell (aromatic). Examples of organoleptic components can include a flavoring agent, a cooling agent, a component with producing a fizzing or tingling sensation, or a particulate texture. Tingling agents can include Jambu extract, Vanillyl alkyl ethers, Vanillyl n-butyl ether, spilanthol, Echinacea extract, Northern Prickly Ash extract, capsaicin, capsicum oleaoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin, menthol glycerin ether, unsaturated amides and combinations thereof. The organoleptic component can be a sweetening agent, a souring agent, a bittering agent, a teeth whitening agent, an anti-cavity agent, a breath freshening agent, and combinations thereof. In other words, organoleptic component can be any sensory-perceived component that can be associated with, or coordinated with ink markings. The organoleptic component can be associated with, complement, emphasize, accentuate, highlight, matches, or otherwise relates to the ink marking. For example, an image of the phrase “cool and refreshing” can be linked to a menthol flavor in the ink composition or an image of berries can be linked to berry flavor.

As used herein, “ink markings” means the regions of ink coverage (transparent and/or colored) on the gum sheet, specifically applied by a dot-on-demand inkjet print head. Specifically, ink markings made with a colored ink means a visually apparent indication on the surface of a gum sheet or portion thereof. Ink markings can be any single color or multiple colors as mentioned above. The ink markings can be an indicia depicting a symbol, object, alpha-numeric representation, letter, word, number (or series thereof), text, number, shape, fanciful shape, image, graphic, patterned color, advertising logo, and/or combination thereof. For example, ink indicia can include images of a person, character, animal, plant, physical object, or scene; advertising indicia can include trade names or trademarks, logos, slogans, and the like or any combination thereof. In an embodiment, ink markings can comprises a geometric design or pattern, such as a spiral, a circle, polka dots, heart shapes, etc., and combinations thereof A “mark” can include a “Sell by” date. One of ordinary skill can appreciate the variety of markings that can provide a visual impression or information to a consumer of the chewing gum product.

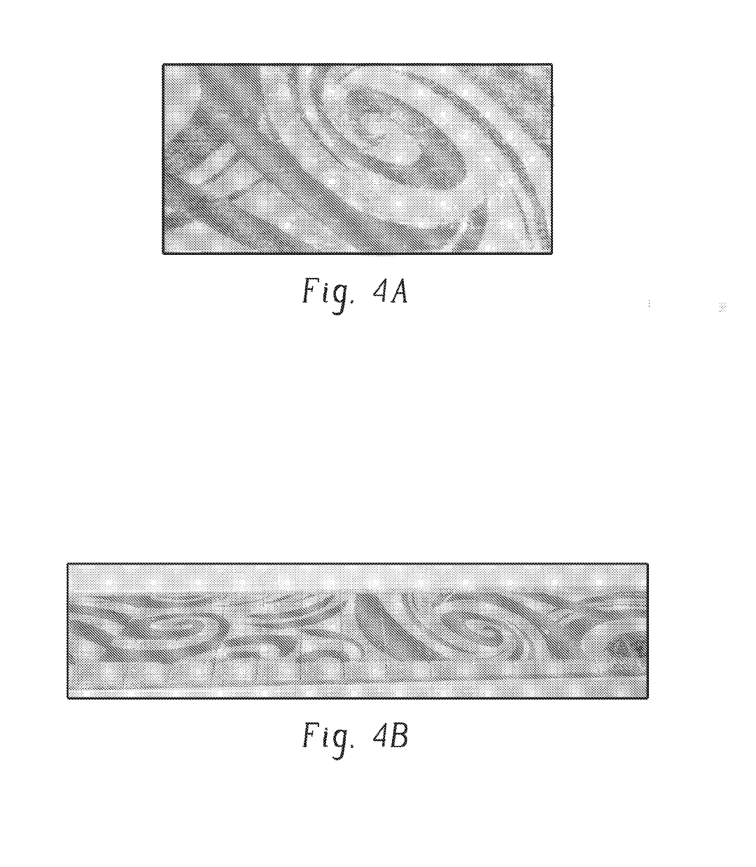

For example, FIG. 4A shows ink markings 401 disposed on the surface of a gum sheet and depicting a spiral. FIG. 4B shows similar ink markings 405 disposed on the surface of pieces of a gum product. In FIG. 4B, the spiral design on a sheet has been divided into sections. Thus, the individual pieces of gum in a package can, in combination, form a recognizable pattern or design, that is, markings on a gum sheet are not adversely affected or damaged when cut into pieces of gum product and the gum pieces can be seen to fit together to form a recognizable image. For example, the gum pieces in a package can form an integral image, design, pattern, or message that is not apparent on individual pieces by themselves. As previously discussed, the spiral or other pattern, design, drawing, or image, can be a single color or multiple colors.

The skilled artisan can appreciate that the ink concentration in the markings can be dependent upon such factors as the rate or speed in which the gum sheet passes under the inkjet printing device, the rate at which the print head ejects the ink droplets, and the like. In one embodiment, ink dot concentration upon the gum sheet can be from about 20.000 dots per square inch to about 150,000 dots per square inch (DPI), specifically 50,000 to 100,000 DPI, or any value there between. In an embodiment, the printing resolution can be greater than 50 DPI, specifically 75 to about 1200 dots per inch or any value there between in the transverse direction. Thus, the inkjet printing system employed in the present method can have a high resolution printing capacity. Following the online printing in the gum manufacture, again referring in particular to the embodiment of FIG. 1, the gum sheet is scored by roller 194, cut into scored sheets by cutting roller 196 and optionally conveyed to a cooling tunnel 200, wherein the scored gum sheets can be cooled from both top and bottom sides with forced air.

In some embodiments, the scoring roller 194 and the dividing roller 196 can be replaced with other gum shaping solutions, such as a drop-roller, a die cutter, pelletizer or other similar gum shaping equipment (provided the sheet is cooled to a sufficient extent). As such, the gum manufacturing system 10 can produce a chewing gum having various final shapes, such as slabs which can subsequently be packaged, or pellets on which printing can occur before or after coating.

The scored sheets can be conditioned in the cooling tunnel 200. As the gum is cooled down, the stickiness of the gum material is reduced, so that gum sheets do not stick together and can be stacked and separated. Likewise, the cooling tunnel can stiffen the gum sheets so as to maintain their shape and minimize material creep. In one embodiment, the cooling tunnel 200 is configured to condition the gum sheets to a temperature as low as about 0° C. to 15° C. The scored sheets are then stacked into stacks of gum sheets 202 and transferred for subsequent packaging processes. In other embodiments, the cooling tunnel 200 can be arranged at different locations in the gum manufacturing system 100. For example, the cooling tunnel 200 can be arranged between the compression roller 192 and the scoring roller 194, such that a gum sheet is cooled before being scored and/or cut. Alternatively, the gum manufacturing system 100 can include additional dividing and/or cutting rollers and packaging equipment for producing packaged gum products in a single line. The gum sheet 20 can be cooled while remaining a continuous web and then cut and scored, as shown in commonly assigned WO 2013/013046 to Jani et al.

The cooling tunnel 200 can be of any conventional type, for example, the cooling chamber disclosed in U.S. Pat. No. 6,214,389 and U.S. Pat. No. 5,756,133 assigned to the predecessor of interest of the present assignee, the teachings and disclosures of which are hereby incorporated by reference in its entirety to the extent not inconsistent with the present disclosure. The cooling tunnel 200 can utilize a forced air cooling mechanism and/or liquid cooled parts such as chilled rollers, chilled belts, chilled steel bands, etc. Further, the cooling tunnel 200 can be compartmentalized including different chambers or areas having different internal temperatures and/or humidity, for example, via force air input of different temperatures and/or humidity. The cooling tunnel 200 can be a long one-pass system. In another embodiment, a cooling tunnel can provide a multi-pass for a continuous gum sheet, as disclosed in WO 2013/013046 A2, hereby incorporated by reference. In the latter case, a series of vertically displaced conveyor belts allow for multiple passes. Upon reaching the end of belt, the gum sheet falls to a lower belt moving in an opposite direction. Such multi-pass system allows both surfaces to be uppermost part of the time. Thus, in an advantageous embodiment, one or more print heads located in cooperation with, or inside, the cooling tunnel can print successively on both surfaces of the gum sheet. In another embodiment, when the gum sheet is printed on only one side, the unprinted surface of the gum sheet can be made to face upwards, for purposes of later packaging so that the printed side shows to the consumer opening the package.

In an embodiment, the internal temperature of the cooling tunnel 200 is maintained at a temperature between 0° C.-25° C., wherein forced air having a temperature between 0° C.-25° C. and/or other chilled rollers, belts, steel bands, etc. having a temperature between 0° C.-25° C. are utilized. An internal humidity level of the cooling tunnel 200 is maintained at between 30% RH-50% RH. A residence time of the gum in the cooling tunnel can be between 30 seconds-10 minutes, depending on the desired temperature of the gum and/or downstream final shaping/packaging processes as well as gum handling capabilities of the cooling tunnel 200 and the form of the gum as it passes through the cooling tunnel 200. The gum exiting the cooling tunnel 200 can have a temperature between 5° C.-20° C. and a temperature gradient throughout the thickness of gum of between having a temperature between 0° C.-1° C. In one embodiment, the continuous sheet of gum is scored into pellets and cooled via the cooling tunnel 200, wherein the cooled sheet is hard enough to be dropped into a bin to break apart. Advantageously, the quality of the printed markings on the printed gum sheets is not adversely affected by the hardening of the gum and its change in temperature, texture, or the like. Although, in the embodiment, the gum manufacturing system 10 includes the cooling tunnel 200, the cooling tunnel 200 is optional.

Various modifications can be made to the embodiment of a gum manufacturing system 10 shown in FIG. 1, as can be appreciated by one of ordinary skill in the art. For example, although the mixing system 102 of FIG. 1 is shown as a continuous line including the gum mixing system 102, the loafing machine 104, and the gum forming system 106, in other embodiments, one or more of these components of the gum manufacturing system 10 can be located in different parts of a manufacturing plant or even in a different manufacturing plant. For example, in one embodiment, the gum mixing system 102 and the loafing machine 104 are located in one plant, and the gum forming system 106 and other subsequent components, such as the scoring and dividing rollers 194, 196 and packaging components, are located in a different plant, wherein the gum loaves 132 formed by the loafing machine 104 are transferred from one plant to the other for subsequent processes. Condense and discuss where the mixing portion of the system is introduced.

In another embodiment, an inkjet printing station can be placed downstream of scoring roller or both cutting roller and scoring roller. The inkjet printing device can also be placed at a location downstream of cutting device 196, but upstream of an optional cooling tunnel or the like for conditioning, in which the gum is in the form of multiple individual sheets when printed with hot-melt ink markings. Alternatively, the gum sheet 20 can be cooled while remaining a continuous web and then cut and scored, as shown in commonly assigned WO 2013/013046 to Jani et al.

In view of the above, one specific embodiment of a method of manufacturing a printed gum product can comprise forming a gum mass into a substantially flat and continuous gum sheet having a substantially uniform thickness and comprising opposing first and second flat surfaces; applying an anti-sticking agent (wherein the gum mass is prevented from adhering to rollers by applying either a liquid release agent or a particulate anti-sticking agent) to the surface of the continuous and flat gum sheet) to the flat surfaces of the flat gum sheet; scoring the continuous gum sheet into a scored continuous sheet; cutting the scored continuous gum sheet into more than one separate scored gum sheet; printing markings onto at least one flat surface of the continuous gum sheet, scored continuous gum sheet, or separate scored gum sheet (collectively “gum sheet”) to obtain a printed gum sheet, wherein a drop-on-demand inkjet printer applies a hot-melt ink that changes phase from a liquid in the inkjet printer to a solid on the surface of the gum sheet, wherein the gum sheet is printed online within 30 minutes of forming and wherein the gum sheet at the time of printing is at a temperature below the melting point of the hot-melt ink.

In another embodiment, a method comprises printing on the substantially continuous and flat gum sheet before or after it is scored. In another embodiment, the method comprises printing on the separated scored sheet. In yet another embodiment, the method comprises printing on the continuous gum sheet and then scoring and cutting the sheet or, alternatively, printing on the scored continuous sheet and then cutting the sheet into separated scored sheets. After printing, but before obtaining gum pieces for packaging, the gum sheet can be optionally conditioned in a cooling tunnel. Still other embodiments of the present method, comprising online printing with an edible hot-melt ink, are shown in the flow charts in FIG. 3. Thus, according to the flow chart of FIG. 3A, a method can comprise printing an edible hot-melt ink onto a gum sheet after cold scoring and de-dusting. The scoring can occur before or after dividing the continuous web into individual sheets. Packing occurs, of course, after printing. Allowance for a brief temporary surge is also shown in FIGS. 3A and 3B. In FIG. 3B, the printing occurs after de-dusting and printing is followed by cold scoring and packing. As shown in FIGS. 3A and 3B, when only one surface of the gum sheet is printed, flipping the gum sheet over prior to packing can allow for the printed surface to show face-up when the package is opened, as compared to the embodiment of FIG. 3B, where the non-printed surface shows to the consumer when the package is opened. This depends, however, on the specific method used to pack the gum.

In another embodiment, the method can further include inkjet printing the edible hot-melt ink onto a gum sheet after it has been cut into sheets and scored, but prior to conditioning to harden the temperature of the gum in a cooling tunnel or the like.

In another embodiment, in order to print on the opposing flat sides of a gum sheet, the gum can be flipped over by various means. In the case of a continuous web of gum, a plurality of separately arranged conveyor belts can switch the position of opposing surfaces. See for example, the conveyor arrangement for reversing the positions of generally flat surfaces of a continuous gum sheet in WO 2013/013046 A2 to Jani et al. so that the surfaces alternately face upward. In the case of individual non-continuous sheets of gum, conveyors can be used that are capable of flipping over the individual sheets. Thus, at least first and second printing devices can be used to print the edible hot-melt ink composition onto opposing flat sides of the gum sheets in sequence. Alternatively, a plurality inkjet printing devices can be arranged in a top/bottom relationship in which suitable openings in a conveyor belt allows printing on a bottom surface of a gum sheet, wherein the at least first and second printing devices are capable of delivering at substantially simultaneously at the same location or sequentially at adjacent locations, along a conveyor belt or the like, the hot-melt ink composition to both opposing sides of the gum sheet.

An advantage of the present online printing is that the gum manufacturing system of FIG. 1 can provide a continuous line from mixing of gum ingredients to packaging of a final gum product. As such, any delays from staging and/or transportation of work-in-process products are substantially reduced or eliminated. Further, the rollers of the forming system 106 and the cooling tunnel 200 can provide sufficient cooling and conditioning such that the finished gum can be immediately packaged without being conditioned in a conditioning room for a relatively long period of time. Such continuous system for manufacturing and packaging of gum products without a lengthy conditioning is especially beneficial for retaining volatile ingredients such as flavors by reducing flash off.

Another aspect of the present disclosure is directed to an edible gum product comprising a plurality of pieces of gum product, optionally packaged together, each piece predesigned for individual consumption at a time, wherein each piece of gum has two substantially flat opposing surfaces, and wherein 1 to 100% of the surface area of at least one surface is covered by dot-on-demand inkjet printer markings that comprise solidified hot-melt ink.

The surfaces of the pieces of gum product can be coated with a liquid release agent, as discussed above, prior to printing of the printed markings. Alternatively, the surfaces of the pieces of gum product have been coated with a particulate anti-sticking powder prior to printing of the printed markings. In one embodiment, the printed markings are printed at a concentration of 50,000 to 100,000 dots per square inch.

The invention is further described in the following illustrative examples in which all parts and percentages are by weight unless otherwise indicated.

### Example 1

In pilot plant trials, various types of hot-melt inks were used printing a swirl pattern using an ink-jet system. An exemplary composition of the hot-melt ink used includes In one experiment, a thin layer of oil was applied to a gum sheet to inhibit sticking. The experiment analyzed printing with a hot-melt inkjet printing. The gum was printed within 30 minutes of forming into sheets, when the surface texture was typically the most difficult for conducting surface treatments.

Results:

When online inkjet printing with hot-melt ink was used, the image quality was very high and the image remained with little or no smudging or smearing. This was observed when rubbing a finger across the surface of the printed gum. In the case of the hot-melt inkjet printing, the hot-melt ink immediately set after printing. As such, hot-melt inkjet printing could advantageously be carried out early on in the process when the gum had a soft surface texture. The hot-melt inkjet printing method delivered a high quality image and the gum could be printed as a continuous web. The hot-melt inkjet printing did not depend on a smooth surface for good resolution. Rotogravure printing was also analyzed in this trial and is contemplated for use in the printing processes and systems discussed herein.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having.” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of manufacturing a gum product, the method comprising:
forming a gum mass into a gum sheet including a preselected sheet thickness profile; and
printing on at least one surface of the gum sheet, wherein the gum sheet is printed online less than 30 minutes after forming the gum sheet.

2. The method of claim 1, further comprising:
separating the gum sheet into a plurality of gum pieces; and
packaging said plurality of gum pieces;
wherein each of said plurality of gum pieces includes a thickness profile at packaging that is substantially the same as a corresponding portion of said preselected sheet thickness profile.

3-7. (canceled)

8. The method of claim 1, further comprising applying an anti-sticking agent to the surfaces of the gum sheet when forming the gum sheet.

9. The method of claim 1, wherein the gum sheet is a continuous gum sheet, the method further comprising scoring the continuous gum sheet into a scored continuous gum sheet before or after printing on the gum sheet.

10-13. (canceled)

14. The method of claim 1, wherein the printing is prior to forced air cooling of the gum sheet.

15. The method of claim 1, wherein the printing takes place in a cooling tunnel in which the gum sheet is conveyed in a serpentine path by a plurality of conveyor belts such that the gum sheet flips over and a lower surface of the gum sheet becomes the upper surface of the gum sheet.

16. The method of claim 15, wherein both sides of the gum sheet are printed when the gum sheet is conveyed under consecutive inkjet print heads before and after the gum sheet flips over.

17-19. (canceled)

20. The method of claim 1, wherein printing comprises employing a drop-on-demand inkjet printer to apply an edible hot-melt ink that changes phase from a liquid in the inkjet printer to a solid on the surface of the gum sheet and wherein the gum sheet at the time of printing is at a temperature below the melting point of the hot-melt ink.

21-24. (canceled)

25. The method of claim 1, wherein the gum sheet is printed online by conveying the gum sheet past the ink printer at a mass velocity that is substantially consistent with the mass velocity of the gum mass that is being formed into the gum sheets.

26. (canceled)

27. The method of claim 1, wherein forming the gum mass comprises employing a plurality of rollers, including at least opposing first and second rollers in order to size the gum mass into the gum sheet.

28. (canceled)

29. The method of claim 1, wherein only one of the surfaces of the gum sheet is subjected to printing and, after printing, the gum sheet is flipped over such that, after the gum product is packaged, a consumer sees a printed surface when opening the packaged gum product.

30-33. (canceled)

34. The method of claim 1, wherein the gum sheet that is formed comprises opposing first and second surfaces, and the gum sheet is printed on both opposing surfaces of the gum sheet, wherein a first and second inkjet printer prints markings on the first and second surfaces of the gum sheet, respectively.

35. (canceled)

36. The method of claim 35, wherein the markings visually and/or transparently covers 10 to 70% of said surface area of the gum sheet.

37. The method of claim 35, wherein the resolution of the markings is at least 50 dots per inch in the transverse direction, perpendicular to the movement of the gum sheet.

38-39. (canceled)

40. The method of claim 1, wherein the printing is carried out by an inkjet printing system comprising a single or a plurality of transversely aligned inkjet print heads.

41. The method of claim 37, wherein one or more inkjet print head is set at an angle between 0 and 30 degrees to the transverse direction of the gum sheet during printing.

42. The method of claim 37, wherein an automated detection device in communication with an inkjet printer system is used to detect the position of the gum sheet to align printing on the gum sheet.

43. The method of claim 37, wherein an edge of the gum sheet is detected by an automatic detection system for determining the position of the gum sheet relative to the inkjet print head.

44-47. (canceled)

48. The method of claim 8, wherein said printing occurs without positively removing, prior to printing, any anti-sticking agent applied to the gum sheet.

49. The method of claim 8, wherein said liquid-release agent is a liquid release agent.

50-51. (canceled)

52. The method of claim 49, further comprising cooling said gum sheet and said liquid release agent remaining with said gum sheet, said cooling causing said liquid release agent to solidify on said gum sheet, either before or during online printing.

53. (canceled)

54. A method of manufacturing a gum product, the method comprising:
forming a gum mass into a gum sheet including a preselected sheet thickness profile;
applying an anti-sticking agent to at least one surface of the gum sheet,
printing on at least one surface of the gum sheet substantially without removing any of the anti-sticking agent, wherein the printing is online.

55. The method of claim 54, wherein the anti-sticking agent is a liquid release agent or a particulate powder.

56-58. (canceled)

59. An edible gum product comprising
a plurality of pieces of gum product, optionally packaged together, each piece predesigned for individual consumption, wherein 1 to 100% of the surface area of at least one surface is visually or transparently covered by dot-on-demand inkjet printer markings that comprise solidified hot-melt ink.

60. The edible gum product of claim 59, wherein surfaces of the pieces of gum product have been coated with a liquid release agent prior to printing of the printed markings.

61-62. (canceled)
